(19) United States
(12) Patent Application Publication
(10) Pub. No.: US 2024/0320285 A1
(43) Pub. Date: Sep. 26, 2024

(54) INTELLIGENT BOOKMARK CATEGORIZATION AND MANAGEMENT

(71) Applicant: International Business Machines Corporation, Armonk, NY (US)

(72) Inventors: Su Liu, Austin, TX (US); Allison Kei Ishida, Alameda, CA (US); Diana Isabelle Ovadia, Camarillo, CA (US); Ravithej Chikkala, Pflugerville, TX (US)

(73) Assignee: International Business Machines Corporation, Armonk, NY (US)

(21) Appl. No.: 18/123,962

(22) Filed: Mar. 20, 2023

(51) Int. Cl. G06F 16/955

(52) U.S. Cl. CPC G06F 16/9562

(57) ABSTRACT

A method for efficiently managing bookmarks is disclosed. In one embodiment, such a method includes monitoring activities that occur in association with creating and maintaining bookmarks in an application such as a web browser. The method learns file structures and associated locations within the file structures into which bookmarks are categorized and saved. Based on this learning, the method creates a file structure template that corresponds to what has been learned. The method then detects creation of a bookmark by a user and automatically categorizes and saves the bookmark into a particular file structure that conforms to the file structure template. A corresponding system and computer program product are also disclosed.

### BACKGROUND

### Field of the Invention

This invention relates generally to techniques for efficiently accessing information, and more particularly to techniques for creating, organizing, and managing bookmarks that are used to access information.

### Background of the Invention

The World Wide Web has placed an enormous amount of information at users' fingertips. Unfortunately, initially finding this information, or returning to desired information once found, can be difficult. In general, servers and resources (e.g., documents, web pages, databases, etc.) on the World Wide Web are identified and located through character strings referred to as uniform resource locators (URLs). Unfortunately, these URLs can be very long, esoteric, and difficult to remember.

For this reason, many web browsers provide functionality to enable users to bookmark web resources (e.g., URLs) that have been discovered. In certain cases, these bookmarks may be organized in folders and sub-folders in accordance with some organizational scheme established by a user. Unfortunately, despite their utility, bookmarks may accumulate over time and become unwieldly and difficult to find. This may undermine the overall purpose of enabling quick and efficient access to information. In some cases, a user may not remember where bookmarks are saved or have to peruse through a large number of bookmarks and associated folders and sub-folders before finding information that the user is looking for.

### SUMMARY

The invention has been developed in response to the present state of the art and, in particular, in response to the problems and needs in the art that have not yet been fully solved by currently available systems and methods. Accordingly, systems and methods have been developed to more efficiently manage bookmarks. The features and advantages of the invention will become more fully apparent from the following description and appended claims, or may be learned by practice of the invention as set forth hereinafter.

Consistent with the foregoing, a method for efficiently managing bookmarks is disclosed. In one embodiment, such a method includes monitoring activities that occur in association with creating and maintaining bookmarks in an application such as a web browser. The method learns file structures and associated locations within the file structures into which bookmarks are categorized and saved. Based on this learning, the method creates a file structure template that corresponds to what has been learned. The method then detects creation of a bookmark by a user and automatically categorizes and saves the bookmark into a particular file structure that conforms to the file structure template.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one example of a file structure that may be used to organize and store bookmarks;

FIG. 3 is a high-level block diagram showing one example of a user interface of a file structure used to organize and store bookmarks;

FIG. 4 is a high-level block diagram showing a bookmark stored in various different location within a file structure;

FIG. 5 is a high-level block diagram showing a bookmark management module and various sub-modules in accordance with the invention;

FIG. 6 is a flow diagram showing interaction between the modules and sub-modules illustrated in FIG. 5; and

FIG. 7 is a process flow diagram showing one embodiment of a method in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “bookmark management module 150”) for managing bookmarks. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

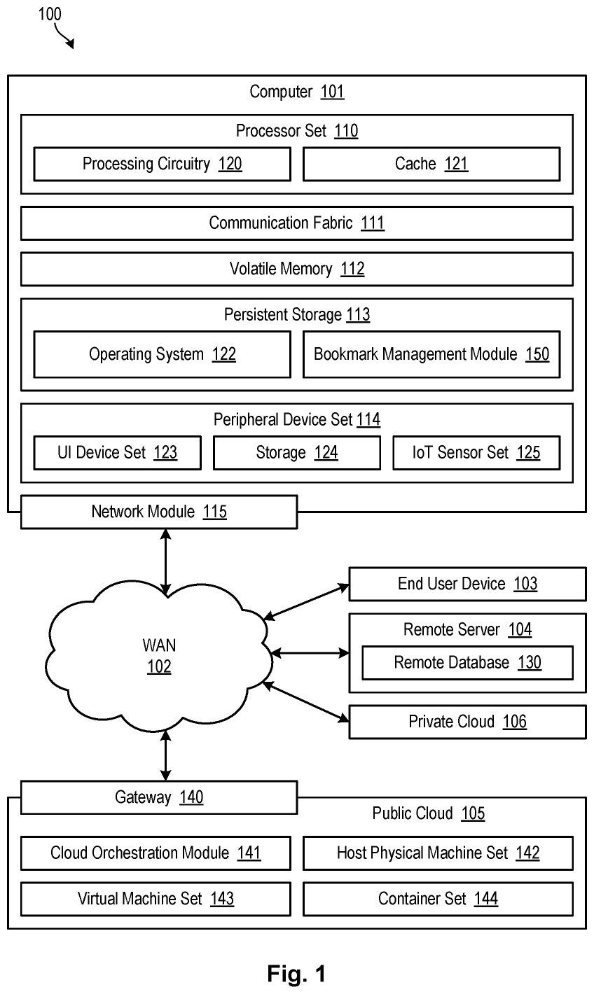

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

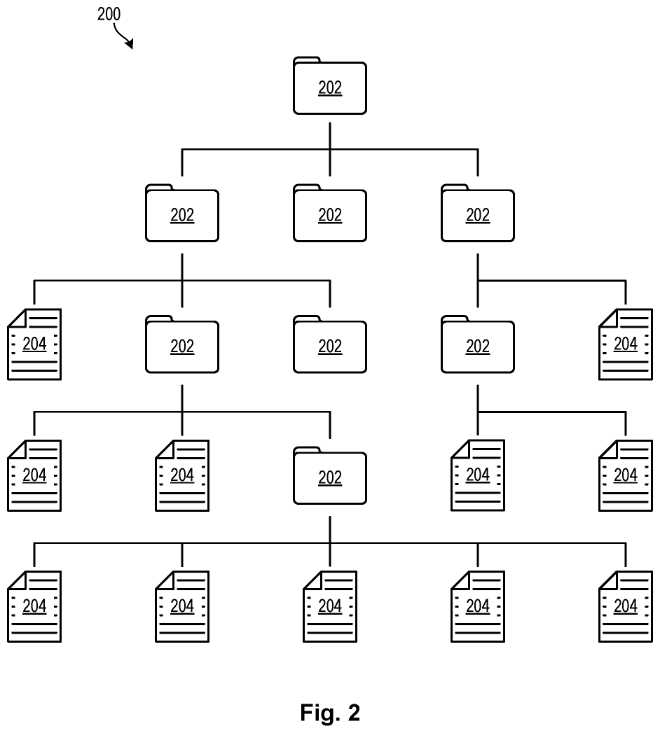

Referring to FIG. 2, as previously mentioned, many web browsers provide functionality to enable users to bookmark web resources (e.g., URLs) that have been discovered. In certain cases, these bookmarks may be organized in folders and sub-folders in accordance with some organizational scheme established by a user. For example, in certain embodiments, bookmarks may be stored in a file structure 200 such as that illustrated in FIG. 2. This file structure 200 may include folders 202 and sub-folders 202 organized in a hierarchical tree structure. Bookmarks 204 may be stored as files in the tree structure. In certain embodiments, each folder 202 corresponds to a particular category of a user's organizational scheme. A bookmark 204 that is deemed to fall within that category may be placed in the corresponding folder 202. In certain embodiments, the folders 202 and sub-folders 202 of the file structure 200 may be named in accordance with the categories that they represent. In certain cases, the bookmarks 204 may also be named in accordance with the category that they fall under or in accordance with some determined naming convention.

Unfortunately, despite their utility, bookmarks may accumulate over time and often become unwieldly and difficult to find. This may undermine the purpose of the bookmarks 204, which is to enable quick and efficient access to information. In some cases, a user may not remember where bookmarks are saved in the folders 202, not remember the names of the bookmarks 204 and/or the folders 202 they are saved in, or have to peruse through a large number of bookmarks and associated folders 202 and sub-folders 202 before finding desired information.

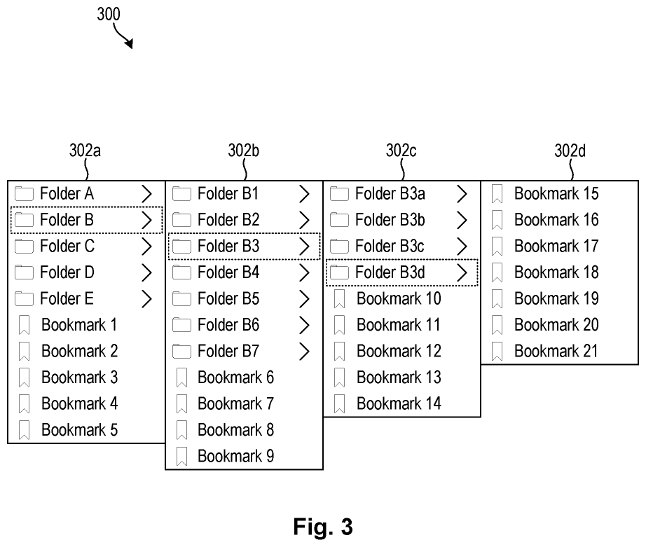

FIG. 3 is a high-level block diagram showing one example of a user interface 300 that may be used to access bookmarks 204 in a file system 200. As shown, in certain embodiments, folders 202 as well as bookmarks 204 may be stored at different layers 302 or levels 302 of the file structure 200. In certain embodiments, finding a bookmark 204 in the file structure 200 may be accomplished by drilling down into the file structure 200. This may be accomplished, for example, by selecting a folder 202 in a first layer 302a of the file structure 200. This may reveal the contents of the folder 202 in a second layer 302b of the file structure 200. Selecting a folder 202 in the second layer 302b may reveal the contents of the folder 202 in a third layer 302, and so forth. Bookmarks 204 may be stored within any of the folders 202 and thus within any of the layers 302.

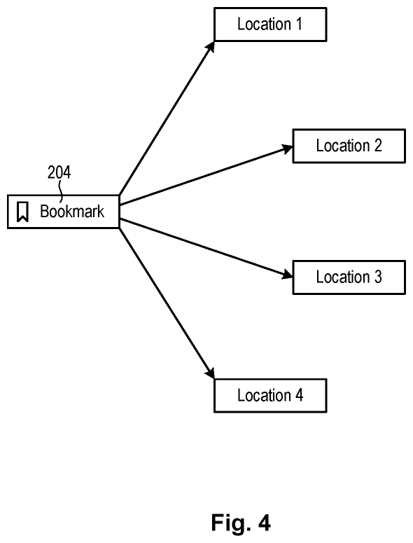

In certain cases, a bookmark 204 may correspond to more than one category within an organizational scheme represented by a file structure 200. Thus, in certain embodiments, it may be desirable to store the same bookmark 204 (with the same or different names) in different locations (e.g., folders 202) within a file system 200, as shown in FIG. 4. These locations may potentially be at different levels 302 or layers 302 within the file structure 200. This may enable a bookmark 204 to be found by following several different paths within a file structure 200. For example, a bookmark 204 for a website or document may be categorized based on its release date, language, subject matter, product offerings, author, or the like. In certain cases, a user may follow a particular pattern or protocol in how the user organizes and categorizes bookmarks 204 within the file structure 200.

Nevertheless, as mentioned above, due to the sheer amount of information on the World Wide Web or other information systems, bookmarks 204 may accumulate to the point where the bookmarks 204 may become unwieldly and difficult to find in the file structure 200. Furthermore, creating bookmarks 204 and inserting them into the file structure 200 in accordance with a user's organizational scheme (potentially at multiple locations within the file structure 200) using correct naming conventions for both the bookmarks 204 and folders 202 can be very time consuming and prone to error. The same inefficiencies may apply to maintaining the file structure 200 and deleting, modifying, and reorganizing bookmarks 204 therein. Thus, it would be an advance in the art to provide tools to assist users in more efficiently managing bookmarks 204.

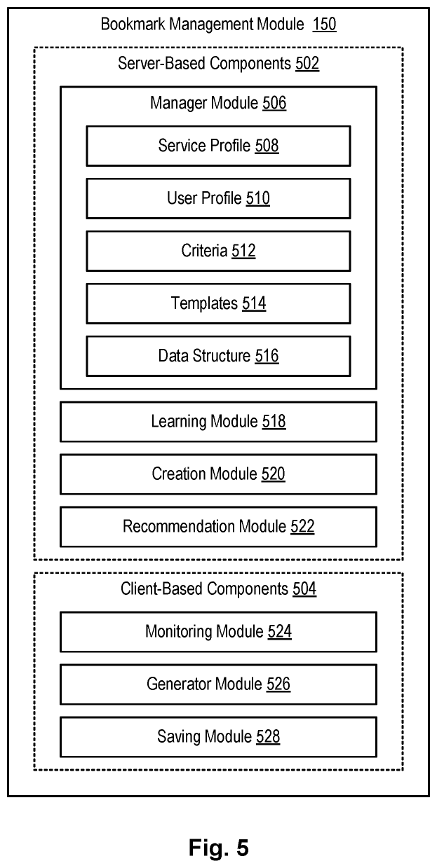

Referring to FIG. 5, in certain embodiments, a bookmark management module 150 in accordance with the invention may be provided to assist a user in more efficiently managing bookmarks 204. As shown, the bookmark management module 150 may include various sub-modules to provide various features and functions. The bookmark management module 150 and associated sub-modules may be implemented in hardware, software, firmware, or combinations thereof. The bookmark management module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the bookmark management module 150 may include one or more of a manager module 506, learning module 518, creation module 520, recommendation module 522, monitoring module 524, generator module 526, and saving module 528. In certain embodiments, these modules may be implemented as server-based components 502 and client-based components 504, although the disclosed functionality is not limited to implementation in a client or server.

As shown, the manager module 506 may manage various types of information, such as a service profile 508 that describes basic service information provided by the bookmark management module 150, including for example service function and behavior. A user profile 510, by contrast, may document specific settings and information associated with a specific user. Criteria 512 may document information such as file structures, folder conventions within file structures, folder and bookmark naming conventions, and the like, for particular users or groups of users. Templates 514 may document file structures 200 and provide patterns or guides for creating new file structures 200 that match or align with previously observed or configured file structures 200. In certain embodiments, a data structure 516 may be maintained for each bookmark 204. This data structure 516 may store attributes for a bookmark 204. For example, the data structure 516 may document a user ID associated with the bookmark 204, a URL associated with the bookmark 204, a name of the bookmark 204, a file structure 200 and/or folders 202 (i.e., categories) in which the bookmark 204 is saved or should be saved, and the like.

As users create and store bookmarks 204, the learning module 518 may learn the users' patterns and preferences with respect to the bookmarks 204. For example, the learning module 518 may learn the types of bookmarks 204 that are created and saved, where the bookmarks 204 are saved (e.g., in which folders 202 and layers 302 of the file structure 200 the bookmarks 204 are saved), and the characteristics of the file structure 200 in which the bookmarks 204 are created and saved. The learning module 518 may also in certain embodiments learn the naming conventions that are used for the bookmarks 204 and folders 202 (i.e., categories). The learning module 518 may do this for any number of users. Where users' bookmarks 204 are stored in the cloud, this learning may occur anonymously and remotely from the users.

Based on what is learned by the learning module 518, the creation module 520 may create templates 514. As mentioned above, these templates 514 may provide patterns or guides for creating or updating file structures 200 for storing bookmarks 204. In certain embodiments, different templates 514 may be created for different types of users (e.g., based on job, title, role, age, hobby, etc.) and may be tailored to the needs of the user. A recommendation module 522, by contrast, may be used to recommend an appropriate template 514 for a user based on previously observed file structures 200 and/or based on the user's needs. A user may or may not accept this recommendation when organizing a file structure 200 to store the user's bookmarks 204.

On the client side, a monitoring module 524 may monitor a user's activities as it relates to creating, organizing, and maintaining bookmarks 204. This information is provided to the learning module 518. When a template 514 is recommended, the generator module 526 may generate a file structure 200 on the client system (or potentially the server system) that conforms to the template 514. The saving module 528 may then save the user's bookmarks 204 into this new file structure 200. In certain embodiments, the saving module 528 saves a bookmark 204 in multiple places (i.e., folders 202 or layers 302) of the file structure 200 in the event the bookmark 204 can be categorized in multiple different ways.

In certain embodiments, the saving module 528 automatically saves bookmarks 204 in particular folders 202 (i.e., categories) of the file structure 200 by analyzing a URL or keywords of a web resource and selecting folders 202 and categories that provide a good fit for the URL and/or keywords. In other embodiments, the saving module 528 enables a user to manually save bookmarks 204 in folders 202 and categories of the file structure 200 that the user deems appropriate.

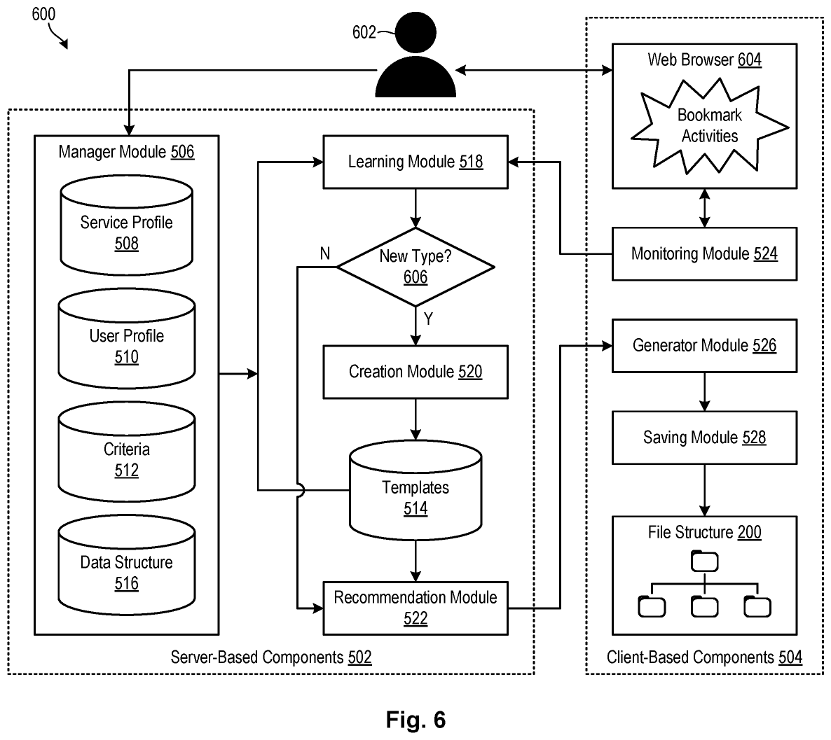

Referring to FIG. 6, a flow diagram 600 showing interaction between the modules and sub-modules of FIG. 5 is illustrated. As shown in FIG. 6, a user 602 interacts with a web browser 604 in performing various bookmarking activities, such as creating, organizing, saving, naming, modifying, and deleting bookmarks 204. The user 602 may also organize a file structure 200, such as by creating, organizing, modifying, deleting, and naming folders 202 in the file structure 200. The monitoring module 524 may monitor any or all of this activity. As further shown, the user 602 may also configure data such as the service profile 508, user profile 510, criteria 512, and data structure 516 that are managed by the manager module 506.

With the data gathered by the monitoring module 524, as well that managed by the manager module 506, the learning module 518 may learn patterns and preferences with regard to the user's utilization and organization of bookmarks 204. If the learning module 518 identifies a new type of pattern or preference at step 606, the creation module 520 may create (or update) a template 514 to reflect the newly observed pattern or preference. This template 514 may be used as a pattern or guide for creating or updating a file structure 200 used to organize bookmarks 204. The recommendation module 522 may recommend an appropriate template 514 for organizing bookmarks 204.

Using this recommendation, the generator module 526 on the client side may generate a file structure 200 from the template 514. This file structure 200 may be used by the web browser 604 on the client. The saving module 528 may save bookmarks 204 in this file structure 200. In certain embodiments, this may include saving a bookmark 204 in multiple locations in the file structure 200, such as in multiple folders 202 and/or layers 302 within the file structure 200 if the bookmark 204 can be categorized in multiple different ways.

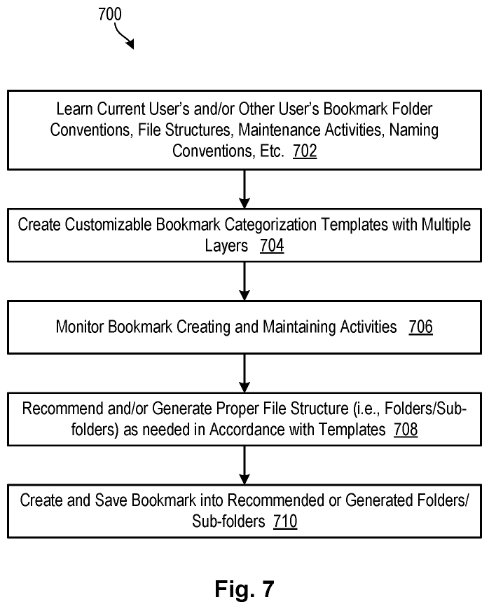

Referring to FIG. 7, a process flow diagram showing one embodiment of a method 700 in accordance with the invention is illustrated. This method 700 may be performed on a client, server, or combination thereof. As shown, the method 700 initially learns 702 a user's and/or other users' bookmark folder conventions, utilized file structures 200, bookmark maintenance activities, bookmark naming conventions, and/or the like. The method 700 then creates 704 a customizable bookmark categorization template 514 with multiple layers 302. The method 700 then monitors 706 bookmark creating and maintaining activities on the client. These activities may be those of a single or multiple users and may occur in association with a web browser 604. The method 700 then recommends 708 and/or generates 708 (or updates) a file structure 200 (a related collection of folders 202 and sub-folders 202) in accordance with the template 514. The method 700 may then create 710 and save 710 a bookmark 204 or bookmarks 204 into the newly created or updated file structure 200.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for efficiently managing bookmarks, the method comprising:
monitoring activity as it relates to creating and maintaining bookmarks;
learning file structures and associated locations within the file structures into which the bookmarks are categorized and saved;
creating a file structure template that corresponds to the learning;
detecting creation of a bookmark by a user; and
automatically categorizing and saving the bookmark into a particular file structure that conforms to the file structure template.

2. The method of claim 1, wherein learning file structures and associated locations comprises learning folders and/or sub-folders into which the bookmarks are categorized and saved.

3. The method of claim 2, wherein learning file structures and associated locations comprises learning naming conventions for the folders and/or sub-folders.

4. The method of claim 1, wherein automatically categorizing and saving the bookmark into a particular file structure comprises automatically categorizing and saving the bookmark into particular folders and/or subfolders in the particular file structure.

5. The method of claim 1, further comprising recommending, to the user, the particular file structure into which to categorize and save the bookmark.

6. The method of claim 1, wherein automatically categorizing and saving the bookmark comprises following a designated bookmark naming convention when categorizing and saving the bookmark.

7. The method of claim 1, wherein monitoring activity comprises monitoring activity of the user.

8. A computer program product for efficiently managing bookmarks, the computer program product comprising a computer-readable storage medium having computer-usable program code embodied therein, the computer-usable program code configured to perform the following when executed by at least one processor:
monitor activity as it relates to creating and maintaining bookmarks;
learn file structures and associated locations within the file structures into which the bookmarks are categorized and saved;
create a file structure template that corresponds to the learning;
detect creation of a bookmark by a user; and
automatically categorize and save the bookmark into a particular file structure that conforms to the file structure template.

9. The computer program product of claim 8, wherein learning file structures and associated locations comprises learning folders and/or sub-folders into which the bookmarks are categorized and saved.

10. The computer program product of claim 9, wherein learning file structures and associated locations comprises learning naming conventions for the folders and/or sub-folders.

11. The computer program product of claim 8, wherein automatically categorizing and saving the bookmark into a particular file structure comprises automatically categorizing and saving the bookmark into particular folders and/or subfolders in the particular file structure.

12. The computer program product of claim 8, wherein the computer-usable program code is further configured to recommend, to the user, the particular file structure into which to categorize and save the bookmark.

13. The computer program product of claim 8, wherein automatically categorizing and saving the bookmark comprises following a designated bookmark naming convention when categorizing and saving the bookmark.

14. The computer program product of claim 8, wherein monitoring activity comprises monitoring activity of the user.

15. A system for efficiently managing bookmarks, the system comprising:
at least one processor;
at least one memory device operably coupled to the at least one processor and storing instructions for execution on the at least one processor, the instructions causing the at least one processor to:
monitor activity as it relates to creating and maintaining bookmarks;
learn file structures and associated locations within the file structures into which the bookmarks are categorized and saved;
create a file structure template that corresponds to the learning;
detect creation of a bookmark by a user; and
automatically categorize and save the bookmark into a particular file structure that conforms to the file structure template.

16. The system of claim 15, wherein learning file structures and associated locations comprises learning folders and/or sub-folders into which the bookmarks are categorized and saved.

17. The system of claim 16, wherein learning file structures and associated locations comprises learning naming conventions for the folders and/or sub-folders.

18. The system of claim 15, wherein automatically categorizing and saving the bookmark into a particular file structure comprises automatically categorizing and saving the bookmark into particular folders and/or subfolders in the particular file structure.

19. The system of claim 15, wherein the instructions further cause the at least one processor to recommend, to the user, the particular file structure into which to categorize and save the bookmark.

20. The system of claim 15, wherein automatically categorizing and saving the bookmark comprises following a designated bookmark naming convention when categorizing and saving the bookmark.
